(19) United States
(12) Patent Application Publication
(10) Pub. No.: US 2021/0301976 A1
(43) Pub. Date: Sep. 30, 2021

(54) MOBILE ACCESSORY GRIP WITH MAGNETIC LOCKING FEATURE

(71) Applicant: PopSockets LLC, Boulder, CO (US)

(72) Inventor: Sam Cohen, Boulder, CO (US)

(21) Appl. No.: 17/265,268

(22) PCT Filed: Jun. 24, 2019
(86) PCT No.: PCT/US2019/038632

§ 371 Date: Feb. 2, 2021

Related U.S. Application Data
(60) Provisional application No. 62/713,839, filed on Aug. 2, 2018.

(51) Int. Cl. F16M 13/06; G06F 1/16; F16M 13/04; A45F 5/10; H04B 1/3827

(52) U.S. Cl. CPC F16M 13/06; G06F 1/1632; F16M 13/04; A45F 5/10; F16B 2001/0035; A45F 2200/0516; A45F 2200/0525; A45F 2200/0508; H04B 1/3827

(57) ABSTRACT

An expandable device includes a base having top and bottom sides, an expanding mechanism operably coupled to the base, a button operably coupled to the expanding mechanism, and first and second magnetic members operably coupled to the base and the button, respectively. The expanding mechanism is selectively movable between a first configuration where the button is disposed in a first, collapsed configuration and a second configuration where the button is disposed in a second, expanded configuration. In the first, collapsed configuration, the first magnetic member engages the second magnetic member to retain the button in the collapsed configuration.

### CROSS-REFERENCE TO RELATED APPLICATION

The present application claims priority to U.S. Provisional Patent Application No. 62/713,839, filed Aug. 2, 2018, the entire contents of which are hereby incorporated by reference.

### FIELD OF THE DISCLOSURE

The present disclosure generally relates to an expandable device and, more particularly, to expandable devices that can be attached to a portable electronic device or a case for a portable electronic device and used as grips, stands, or for other purposes.

### BACKGROUND

Portable electronic devices, such as MP3 players and smart phones, are often housed in protective covers or cases in order to protect the device from damage, provide a grip for handling the device, and/or provide a stand for propping the device on a surface. Such cases increase the effective size of the device. Expandable devices and accessories, which may be attached directly to the device or to the case protecting the device, are used for a variety of functions, including propping the device on a surface and providing an expandable grip for handling the device. The expandable devices have decorative buttons, which may display logos, decals, symbols, or other artistic renderings.

### SUMMARY

In accordance with one aspect, an expandable device includes a base having top and bottom sides, an expanding mechanism operably coupled to the base, a button operably coupled to the expanding mechanism, and first and second magnetic members operably coupled to the base and the button, respectively. The expanding mechanism is selectively movable between a first configuration where the button is disposed in a first, collapsed configuration and a second configuration where the button is disposed in a second, expanded configuration. In the first, collapsed configuration, the first magnetic member engages the second magnetic member to retain the button in the collapsed configuration.

In some approaches, at least one of the first magnetic member or the second magnetic member is embedded in the base or the button. In other examples, the first magnetic member is disposed on the top side of the base and/or the second magnetic member is disposed on the bottom side of the button.

In some examples, the expandable device may be in the form of at least one spring arranged between the base and the button. In some forms, a pair of concentric springs may be used. A cover may be coupled to the base to at least partially surround the spring. The cover may be in the form of a skin constructed from an elastomeric material. Further, the cover may have a tapered conical shape, and may also include at least one folding section having an accordion shape.

In some approaches, the expandable device may further include a quarter turn coupling that is operably coupled to the base and the button. The quarter turn coupling assists in retaining the button in the collapsed configuration.

In accordance with another aspect, an approach for operating an expandable device for a portable electronic device includes moving an expandable mechanism of the expandable device from a collapsed configuration to an expanded configuration. In the expanded configuration, the expandable mechanism projects upwardly from a base of the expandable device. The approach further includes moving the expandable mechanism from the expanded configuration to the collapsed configuration. Upon moving the expandable mechanism from the expanded configuration to the collapsed configuration, a first magnetic member coupled to the base engages a second magnetic member coupled to a button of the expandable device.

### BRIEF DESCRIPTION OF THE DRAWINGS

The above needs are at least partially met through provision of the expandable device for a portable electronic device described in the following detailed description, particularly when studied in conjunction with the drawings, wherein:

FIG. 1A illustrates a side elevation view of an expandable device in accordance with various embodiments;

FIG. 1B illustrates a side elevation view of an alternative expandable device having a cover member in accordance with various embodiments;

FIG. 2 illustrates a side isometric, cutaway view of a second example expandable device in accordance with various embodiments;

FIG. 3A illustrates a side elevation view of an example expandable device having an alternate expanding mechanism in accordance with various embodiments;

FIG. 3B illustrates the example expandable device of FIG. 3A in an expanded configuration in accordance with various embodiments; and

FIG. 4 illustrates a perspective view of an example expandable device having a quarter turn coupling configuration in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, expandable devices for portable electronic devices are provided that include a base and an expanding mechanism that is movable relative to the base between a collapsed configuration and an expanded configuration. The expandable devices may further include a button coupled to the expanding mechanism. The button is securable to the base via a plurality of magnetic members operably coupled to and/or carried by the base and the button.

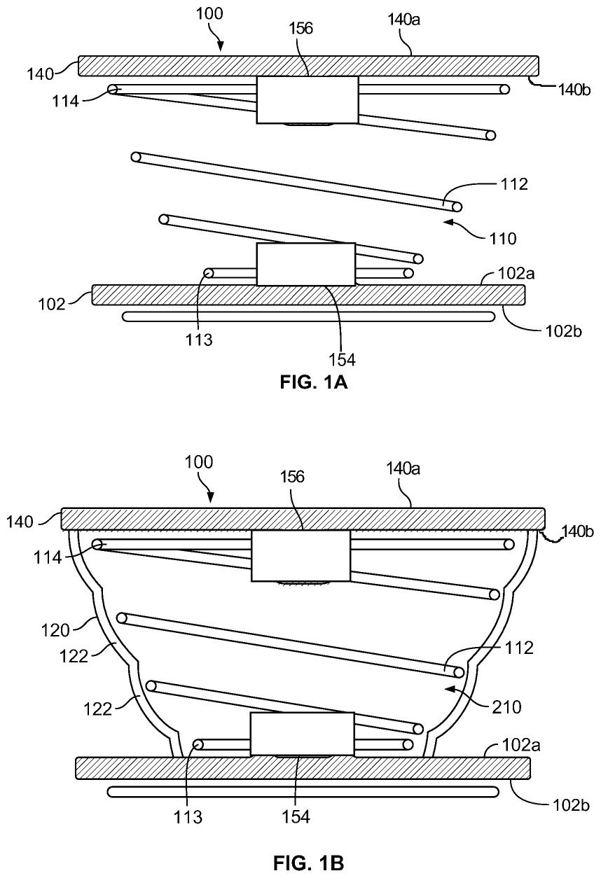

A first embodiment of an expandable device 100 is shown in FIGS. 1A and 1B. The expandable device 100 includes a base 102 having a top or upper side 102a and a bottom or lower side 102b, a collapsible and/or expandable mechanism 110 operably coupled to the base 102, a button 140 having a top or upper side 140a and a bottom or lower side 140b, a first magnetic member 152, and a second magnetic member 154. The base 102 has a top or upper side 102a and a bottom or lower side 102b.

The base 102 may have any desired shape (e.g., an annular shape) and is preferably constructed from metal or plastic, though other suitable materials (e.g., cardboard) can be used. In any case, the bottom side 102b of the base 102 is generally configured to be directly or indirectly coupled (e.g., attached, mounted) to a portable media player (e.g., an MP3 player, a smart phone, a tablet) or a case of such a portable media player. To this end, the base 102 can, in some cases, include a securing element known to one of ordinary skill in the art, such as, for example, adhesive, glue, tape, a suction cup, a snap-fit connection, a friction fit, other means, or combinations thereof. Alternatively, in other cases, the base 102 can be integrally formed with the portable media player or the case for the portable media player.

The expandable mechanism 110 generally facilitates movement of the expandable device 100 between an expanded configuration (illustrated in FIGS. 1A & 1B), and a collapsed configuration (not shown), and to retain the expandable device 100 in the desired configuration (expanded or collapsed). In this example, the expandable mechanism 110 is in the form of a coil spring 112 that is arranged between the base 102 and the button 140. The coil spring 112 may be constructed from any number of suitable materials such as, for example, metal or plastic. The coil spring 112 has a first end 113 that is seated against the upper side 102a of the base 102 and a second end 114, opposite the first end 113, that is seated against the bottom side 140b of the button 140. The coil spring 112 has a conical or tapered shape, such that the first end 113 has an outer diameter that is smaller than an outer diameter of the second end 114.

The button 140 includes a top or upper side 140a and a bottom or inner side 140b and is operably coupled to the expandable mechanism 110. The button 140 may have an annular shape. In other examples, however, the button 140 may have a rectangular, square, triangular, irregular, or other shape. The button 140 in this example also has an outer diameter that is larger than an outer diameter of the base 102, though this need not be the case. Like the base 102, the button 140 is preferably constructed from metal or plastic, though other suitable materials can be used.

The button 140 may be removable from the expandable device 100. The button 140 may have artistic value (e.g., the button 140 may include an artistic rendering, a logo, a symbol, text, or a decal), the button 140 may provide a grip that allows a user to slide their fingers between the bottom side 140b and the base 102 when the expandable mechanism 110 is in the expanded configuration such that the top side 140a of the button 140 is disposed adjacent to the palm of the user's hand, and may also provide a space in which a cord, such as a cord for earphones, may be wrapped and stored around a portion of the base 102. As such, in some examples, it may be desirable to remove the button 140 and replace it with another button 140 that features a different aesthetic design and/or provides a different grip so as to change the look and/or function of the expandable device 100.

The first and second magnetic members 154, 156 may be any type of suitable magnets. For example, each and/or both of the magnetic members 154, 156 may be neodymium iron boron, samarium cobalt, alnico, and/or ceramic or ferrite magnets. The magnetic members 154, 156 may have any desired coercive force. In the illustrated examples, the first magnetic member 154 is disposed on the top side 102a of the base 102. Similarly, the second magnetic member 156 is disposed on the bottom side 140b of the button 140. The first and second magnetic members 154, 156 may be coupled to the base 102 and the button 140 using any number of suitable approaches such as, for example, adhesives. In some examples, the base 102 and the button 140 may define protrusions in which the first and/or the second magnetic member 154, 156 may be frictionally retained. In some examples, the first and/or the second magnetic member 154, 156 may be flush mounted into the base 102 and/or the button 140. In this configuration, the first and/or the second magnetic member 154, 156 may not protrude from the top side 102a of the base 102 and/or the bottom side 140b of the button 140. Other examples are possible.

In these examples, the coil spring 110 is arranged to bias the expandable device 100 towards its expanded configuration. More particularly, the coil spring 110 is arranged to bias the button 140 away from the base 102 to the position shown in FIGS. 1A & 1B, which correspond to the expanded configuration of the expandable device 100. Thus, the coil spring 110 may also be referred to herein as the biasing element. In any case, when the expandable device 100 is in the expanded configuration, the button 140 is spaced from the base 102 so as to permit the user of the expandable device 100 to wrap a headphone cord of the portable media player around a portion of the expandable device 100, forming an adjustable stand for the portable media player, forming a grip for the portable media player, and/or to perform other desired functionality.

In operation, the expandable device 100 may be moved from the expanded configuration to the collapsed configuration by overcoming the biasing force applied by the coil spring 110. Generally speaking, the user of the expandable device 100 may accomplish this by grabbing or grasping the button 140 and moving (e.g., pushing) the button 140 towards the base 102. As the button 140 is moved toward the base 102 in this manner, a magnetic force between the first and second magnetic members 154, 156 become sufficiently strong to couple the two magnetic members to each other, thereby retaining the button 140 in the collapsed configuration.

The button 140 may be positioned in the expanded configuration by grasping or pulling the button 140 away from the base 102 with a sufficient force to overcome the magnetic force between the first magnetic member 154 and the second magnetic member 156. Upon doing so, the coil spring 112 will urge the button 140 to the expanded configuration.

As illustrated in FIG. 1B, the expandable device 100 further includes a deformable cover 120 that is coupled to the base 102 and/or the button 140 in a manner that surrounds and houses the expanding mechanism 110 for safety and comfort, and may further include a lock (not shown) configured to releasably secure the expandable device 100 in a collapsed configuration that is not shown but is consistent with the collapsed configuration of the expandable device described above. The cover 120 is generally coupled to and disposed between the button 140 and the base 104. Generally, the cover 122 has a shape that substantially corresponds to the shape of the coil spring 112. The cover 120 preferably takes the form of an elastomeric skin constructed from an elastomeric material that includes a plurality of folding sections 122 connected to one another between the button 140 and the base 102. In some examples, the plurality of folding sections 122 are arranged so as to form or define a tapered conical shape that resembles an accordion. Thus, in these examples, the cover 120 has an outer diameter that tapers from the button 140 to the base 102 (though in other examples, the opposite is possible as well). In other examples, the plurality of folding sections 122 may be arranged to form a different shape or the cover 120 may only include a single folding section 122.

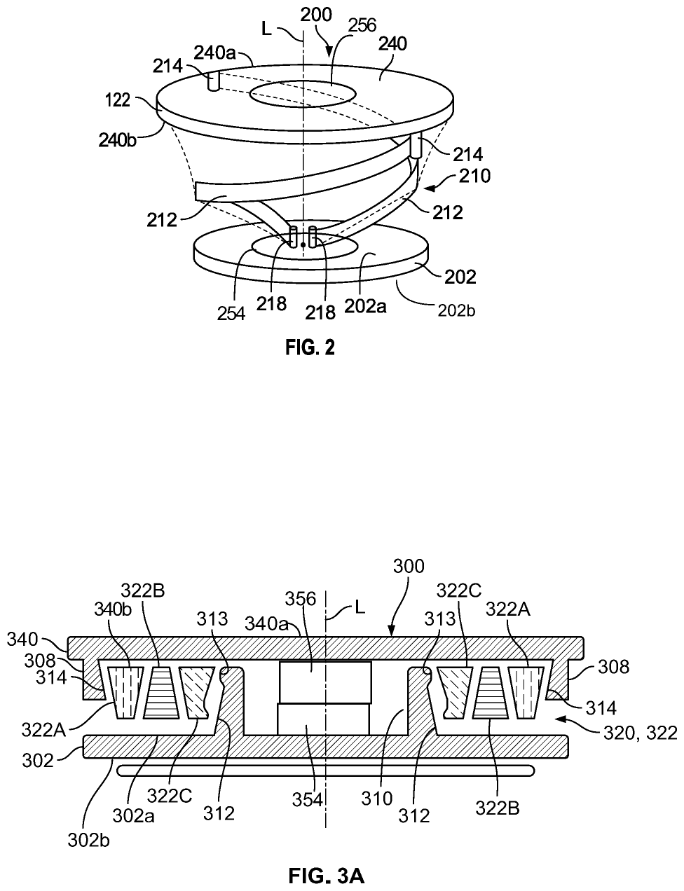

A second embodiment of an expandable device 200 is illustrated in FIG. 2. It will be appreciated that the expandable device 200 illustrated in FIG. 2 may include similar features to the expandable device 100, and thereby elements illustrated in FIG. 2 are designated by similar reference numbers indicated on the embodiment illustrated in FIGS. 1A & 1B, increased by 100. Accordingly, these features will not be described in substantial detail. The expandable device 200 in this example includes a base 202, a button 240, and a collapsible or expandable mechanism 210 coupled to and extending between the button 240 and the base 202. The expandable device 200 may also include a deformable cover (e.g., a cover as illustrated in FIG. 1B) that is coupled to the button 240 and/or the base 202 in a manner that surrounds and houses (e.g., protects) the expandable mechanism 210 for safety and comfort.

The collapsible or expandable mechanism 210 is in the form of two, thin strip springs 212 arranged within the cover (not shown), with each spring 212 having a first end 214 coupled (e.g., mounted) to the bottom surface 240b of the button 240, and a second end 218 coupled (e.g., mounted) to the top surface 202a of the base 202. The first end 214 of the each strip 212 is preferably coupled to the bottom surface 240b of the button 240 at or proximate to a perimeter edge thereof, and the second end 218 of each strip 212 is preferably coupled to the top surface 202a of the base 202 at or proximate to a center thereof. The first end 214 of each spring 212 may be removably coupled to the button 240, fixedly coupled to the button 240, or integrally formed with the button 240. Likewise, the second end 218 of each spring 212 may be removably coupled to the base 202, fixedly coupled to the base 202, or integrally formed with the base 202.

In one example, the strips 212 are fabricated from spring steel or comparable metal. In another example, the strips 212 are produced from a stiff, flexible polymer. In any case, the strips 212 are preferably formed such that they are bistable, i.e., they each have two stable states in which they resist movement (at least initially), with one of the stable states being the expanded state shown in FIG. 2, which corresponds to the expanded configuration of the expandable device 200, and the other of the stable states being the collapsed state (not shown). Thus, when the strips 212 are in the expanded state shown in FIG. 2, the strips 212 maintain (e.g., bias) the expandable device 200 in the expanded configuration, and when the strips 212 are in the collapsed state, the strips 212, when combined with the magnetic members 254, 256, maintain (e.g., bias) the expandable device 200 in the collapsed configuration.

In operation, the expandable device 200 may be transitioned between the two configurations by manipulating the button 240 between the two stable states. A user may grab or grasp and rotate the button 240 about a longitudinal axis L, which will in turn rotate the button about the same longitudinal axis L, and/or by grabbing or grasping the cover (not shown), which carries the button 240, and rotating the cover about the longitudinal axis L. The strips 212 will, in turn, rotate about the longitudinal axis L, with the exact direction of rotation dependent upon whether the expandable device 200 is being moved to the expanded configuration or the collapsed configuration. When, for example, the expandable device 200 is moved from the expanded configuration to the collapsed configuration, the button 240 and the strips 212 will rotate in a first rotational direction (e.g., a counter-clockwise direction) about the longitudinal axis L, thereby moving the button 240, the strips 212, and the cover toward the base 202 along the longitudinal axis L in a first axial direction, and substantially reducing the profile of the expandable device 200. Conversely, when the expandable device 200 is moved from the collapsed configuration to the expanded configuration, the button 240, the strips 212, and the cover will rotate in a second direction, opposite the first direction, about the longitudinal axis L, thereby moving the button 240, the strips 212, and the cover away from the base 202 along the longitudinal axis L in a second axial direction opposite the first axial direction. Thus, the button 240 is spaced from the base 202 so as to permit the user of the expandable device 200 to wrap a headphone cord of the portable media player around a portion of the expandable device 200, forming an adjustable stand for the portable media player, forming a grip for the portable media player, and/or to perform other desired functionality.

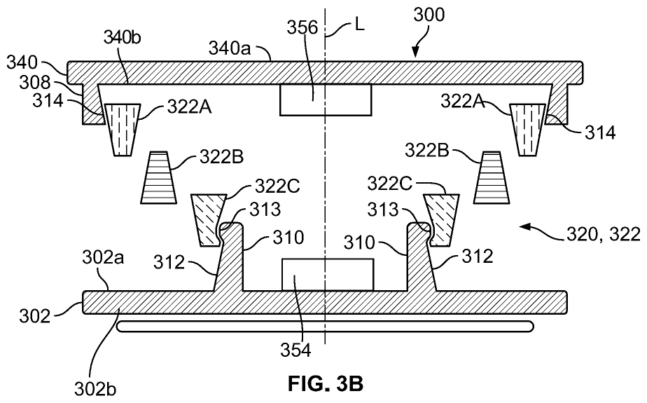

A third embodiment of an expandable device 300 is illustrated in FIGS. 3A & 3B. It will be appreciated that the expandable device 300 illustrated in FIGS. 3A & 3B may include similar features to the expandable device 100 and 200, and thereby elements illustrated in FIGS. 3A & 3B are designated by similar reference numbers indicated on the embodiments illustrated in FIGS. 1A-2, increased by 100 or 200. Accordingly, these features will not be described in substantial detail. The expandable device 300 in this example includes a base 302, a button 340, and a collapsible or expandable mechanism 320 coupled to and extending between the button 340 and the base 302. The expandable device 300 further includes a lock configured to releasably secure the expandable device 300 in an expanded configuration (shown in FIG. 3B). In other examples, the expandable device 300 may include additional, fewer, or different components. As an example, the expandable device 300 may also include a deformable cover.

As with the expandable mechanisms 110, 210, the expandable mechanism 320 generally facilitates movement of the expandable device 300 between a collapsed configuration, shown in FIG. 3A, and the expanded configuration shown in FIG. 3B. However, the expandable mechanism 320 in this example takes the form of a plurality of concentric rings 322 arranged between the button 340 and the base 302. In this example, the expandable mechanism 320 includes three concentric rings 322A, 322B, and 322C each having a substantially wedge-shaped cross-section, though in other examples, fewer or more concentric rings may be employed and/or the concentric rings may have a different shape. The concentric rings 322 are movable relative one another along a longitudinal axis L as the expandable device 300 moves between the collapsed and expanded configurations. Moreover, as illustrated in FIGS. 3A and 3B, the concentric ring 322B is movable within the concentric ring 322A and the concentric ring 322C is movable within the concentric ring 322B (and, in turn, the ring 322A) as the expandable device 300 moves between the collapsed and expanded configurations.

The button 340 in this example is similar to the button 140 described above, with common components referred to using common reference numerals. The button 340 additionally includes a first, annular projection 308 that is carried by and extends axially inward of and from the bottom side 340b of the button 340 at or proximate to a perimeter edge thereof. The projection 308 in this example has an inner surface 314 that curves radially inward as the projection 308 extends away from the button 340. The inner surface 314 is therefore arranged to interface with an outermost one of the concentric rings 322 (the concentric ring 322A in this example) to assist in maintaining the concentric rings 322 in the proper position between the button 340 and the base 302.

The base 302 in this example is similar to the base 102 described above, with common components referred to using common reference numerals. However, unlike the base 102, the base 302 includes a second, annular projection 310 that is carried by and extends axially inward of and from the top side 302a of the base 302. The second projection 310 is disposed radially inward of both the first projection 308 and the concentric rings 322. In other words, the second projection 310 is nested within the first projection 308 and the concentric rings 322. The second projection 310 has an outer surface 312 that tapers as the projection 310 extends away from the base 302. A detent 313 is formed at or proximate to an end of the outer surface 312. The detent 313 is thus arranged to interface with an innermost one of the concentric rings 322 (the concentric ring 322C in this example) to help maintain the concentric rings 322 in the proper position between the button 340 and the base 302. In some examples, such as the one illustrated in FIGS. 3A and 3B, the innermost concentric ring 322 (322C in this example) may also include a groove that is sized to receive and interferingly engage the detent 313 in order to further help maintain the concentric rings 322 in the proper position.

As with the expandable devices 100, 200, the expandable device 300 includes a first and second magnetic member 354, 356 coupled to the base 302 and the button 340 using any number of desired approaches.

In operation, the expandable device 300 may be transitioned between the expanded and collapsed configurations by manipulating the button 340 and/or the mechanism 320. More particularly, the user of the expandable device 300 may move the expandable device 300 from the collapsed configuration (FIG. 3A) to the expanded configuration (FIG. 3B) by, for example, grabbing or grasping the button 340 and moving (e.g., pulling) the button 340 upward, away from the base 302, along the longitudinal axis L. As briefly mentioned above, the expandable device 300 includes a lock that may in turn lock, or securely retain, the expandable device 300 in this expanded configuration. In this example, the lock is a friction-based lock that is defined by the detent 313 and the inner surface 315, which not only help to maintain the concentric rings 322 in the proper position between the button 340 and the base 302, but also respectively frictionally engage the innermost and outermost of the concentric rings 322 (322C and 322A, respectively, in this example) when the expandable device 300 is in the expanded configuration In this example, the concentric rings 322 are also shaped so as to frictionally engage one or both adjacent concentric rings 322 when the expandable device 300 is in the expanded configuration, thereby helping to lock the expandable device 300 in the expanded configuration. The user of the expandable device 300 may release or disengage these locking features, and move the expandable device 300 from the expanded configuration to the collapsed configuration, by, for example, moving (e.g., pushing, pressing) the button 340 downward, toward the base 302, along the longitudinal axis L. As the expandable device 300 is moved from the expanded configuration to the collapsed configuration, the concentric rings 322 nest within one another, with the innermost ring 322 nesting within the next innermost ring 322 and so on, until the projection 310 is positioned immediately adjacent or in contact with the inner side 116 of the button 340. The attractive force between the first and second magnetic members 354, 356 then act to secure the expandable device 300 in the collapsed configuration until a user pulls the button 340 with sufficient force to overcome the magnetic force.

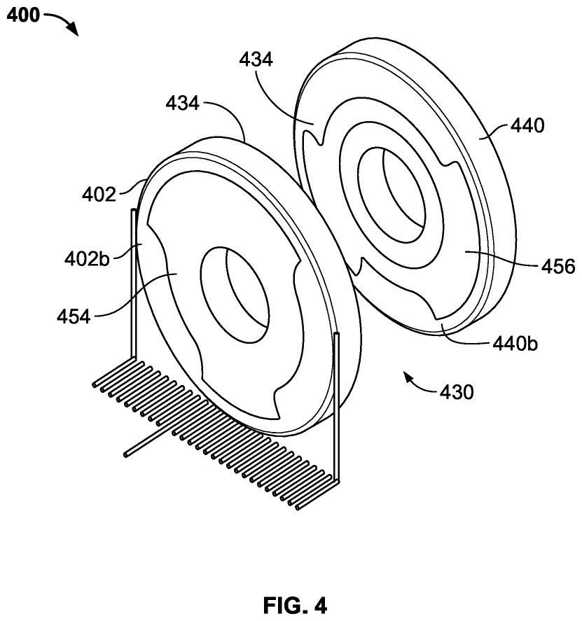

An additional embodiment of an expandable device 400 is illustrated in FIGS. 3A & 3B. It will be appreciated that the components illustrated in FIG. 4 may include similar features to the expandable devices 100, 200, and 300, and thereby elements illustrated in FIG. may not be included and/or are designated by similar reference numbers indicated on the embodiments illustrated in FIGS. 1A-3B. Accordingly, these features will not be described in substantial detail. In this example, the expandable device may be further secured in the collapsed configuration by way of a quarter turn arrangement 430. In these examples, the button 440 and the base 402 may each carry a raised slotted protrusion 432, 434 that engages the corresponding protrusion on the other component by twisting or turning the button 440. So configured, the expandable device 400 will be further retained in the collapsed configuration until the button 400 is rotated in the opposite direction and the user exerts a sufficient force to overcome the magnetic force between the first and second magnetic members 454, 456.

In some instances, the expandable grip accessory of the current disclosure may be in the form of a commercially available grip and stand product such as that available on www.popsockets.com. For example, U.S. Pat. No. 8,560,031, filed on Feb. 23, 2012; U.S. Pat. No. 9,970,589, filed on Nov. 9, 2017; U.S. application Ser. No. 15/615,900, filed on Jun. 7, 2017; U.S. application Ser. No. 15/679,934, filed on Aug. 17, 2017; U.S. application Ser. No. 15/803,410, filed on Nov. 3, 2017; U.S. application Ser. No. 15/808,076, filed on Nov. 9, 2017; U.S. application Ser. No. 15/864,402, filed on Jan. 8, 2018; U.S. application Ser. No. 15/864,509, filed on Jan. 8, 2018; U.S. application Ser. No. 15/906,920, filed on Feb. 27, 2018; U.S. application Ser. No. 15/922,601, filed on Mar. 15, 2018; U.S. application Ser. No. 15/952,025, filed on Apr. 12, 2018; U.S. application Ser. No. 15/993,458, filed on May 30, 2018; and U.S. application Ser. No. 16/001,723, filed on Jun. 6, 2018 each describe suitable expandable grip and stand product, which also incorporate collapsible mechanisms, the entirety of each being hereby incorporated by reference.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s).

1. An expandable device for attachment to a portable electronic device, the expandable device comprising:
a base having a top side and a bottom side, the bottom side adapted to engage a portion of the portable electronic device or a case for the portable electronic device;
an expanding mechanism operably coupled to the base;
a button having a top side and a bottom side, the bottom side of the button being operably coupled to the expanding mechanism;
a first magnetic member operably coupled to the base; and
a second magnetic member operably coupled to the button;
wherein the expanding mechanism is selectively movable between a first configuration whereby the button is disposed in a first, collapsed configuration and a second configuration whereby the button is disposed in a second, expanded configuration, wherein in the first, collapsed configuration, the first magnetic member engages the second magnetic member to retain the button in the collapsed configuration.

2. The expandable device of claim 1, wherein at least one of the first magnetic member or the second magnetic member is embedded in the base or the button.

3. The expandable device of claim 1, wherein the first magnetic member is disposed on the top side of the base.

4. The expandable device of claim 1, wherein the second magnetic member is disposed on the bottom side of the button.

5. The expandable device of claim 1, wherein the expandable device comprises at least one spring arranged between the base and the button.

6. The expandable device of claim 5, wherein the spring comprises a pair of concentric springs.

7. The expandable device of claim 5, further comprising a cover coupled to the base, the cover configured to at least partially surround the spring.

8. The expandable device of claim 7, wherein the cover comprises a skin constructed from an elastomeric material.

9. The expandable device of claim 7, wherein the cover comprises a tapered conical shape.

10. The expandable device of claim 7, wherein the cover comprises at least one folding section having an accordion shape.

11. The expandable device of claim 1, further comprising a quarter turn coupling operably coupled to the base and the button to retain the button in the collapsed configuration.

12. A method of operating an expandable device for a portable electronic device, the method comprising:
moving an expandable mechanism of the expandable device from a collapsed configuration to an expanded configuration whereby the expandable mechanism projects upwardly from a base of the expandable device; and
moving the expandable mechanism from the expanded configuration to the collapsed configuration;
whereby upon moving the expandable mechanism from the expanded configuration to the collapsed configuration, a first magnetic member coupled to the base engages a second magnetic member coupled to a button of the expandable device.

13. The method of claim 12, wherein the expandable device comprises at least one spring arranged between the base and the button.

14. The method of claim 13, wherein the spring comprises a pair of springs.

15. The method of claim 13, wherein the engagement between the first magnetic member and the second magnetic member overcomes an urging force exerted by the spring to retain the expandable device in the collapsed configuration.
